(19) United States
(12) Patent Application Publication
(10) Pub. No.: US 2002/0071894 A1
(43) Pub. Date: Jun. 13, 2002

(54) Apparatus and method for baking bread using a partial vacuum

(75) Inventor: Christian Acknin, Terssac (FR)

Correspondence Address: Harrison & Egbert, 412 Main St., 7th Fl., Houston, TX, 77002, US

(73) Assignee: Societe Altec S.A.R.L.

(21) Appl. No.: 09/949,869

(22) Filed: Sep. 10, 2001

Related U.S. Application Data
(63) Continuation of application No. 09/367,726, filed on Oct. 12, 1999, now abandoned.
Application No. 09/367,726 is a 371 of international application No. PCT/FR98/00326, filed on Feb. 19, 1998.

(30) Foreign Application Priority Data
Feb. 19, 1997 (FR) 97/02133

(51) Int. Cl. A21D 13/00

(52) U.S. Cl. 426/446

(57) ABSTRACT

A microwave oven for baking dough which uses a partial vacuum to bring about expansion of the dough. Microwaves and infrared radiation are used simultaneously or successively for fixing the dough in the expanded position. A rotation device is used to rotate the baking dough about a vertical axis and along the length of this axis so as to homogenize the dough. An automatic system for handling the dough is provided so as to allow for the insertion of hot plates into the oven and for the removal therefrom.

### BACKGROUND OF THE INVENTION

1. Field of the Invention

The invention presented here involves a pastry or dough baking oven, for example, for pizzas or tarts, of the microwave oven type, using a combination of treatment under partial vacuum, baking mechanisms, and movements of the object to be baked, simultaneously or successively, in order to optimize the quality of the baking, reduce its duration and to make easier its control from a dough made of flour and water without a rising agent.

2. Description of Related Art

In the state of the art, pastry or dough baking ovens traditionally consist of a combination of different baking mechanisms such as infrared and/or microwaves in order to bake the pastry or dough each time in depth and on the surface, but their functioning is restricted in duration by the rising time of the pastry or dough. The use of the vacuum in baking ovens limits the creation of a partial vacuum either in order to make the extrusion of the pastry or dough easier according to a desired form of the cake or in order to make easier the dehumidification of the pre-baked or baked pastry or dough by creation of a vapor due to the reduced pressure and the temperature of the pastry or dough leaving the oven. The use of the vacuum within the oven itself in order to cause the rise of the pastry or dough at the same time that it is seared and baked was not done until the present time in known ovens for baking pastry.

The patent WO 95/04445 describes an oven that consists of a heating component and a pump to reduce the pressure with the goal of reducing the heat of the baking, which has the effect of not damaging the food.

The water necessary for the baking is contained in a tray at the base of the oven, by the effect of the vacuum, the temperature of vaporization of this water is lowered according to the principle of Mariotte's Law.

The European patent 0 586 035 Alternatively, describes an oven that consists of a heating element and a vacuum pump in which the vacuum is used in order to make the humidity contained in the products made into bread evaporate. These products contain rising agents which cause the growth of the pastry or dough.

In case the pastry or dough is made at the time of the baking, or a very short time beforehand, in order to be baked in the automated machines from the portion containing the water and the pastry or dough, it is not possible to use rising agents whose action requires a certain amount of time.

In addition, in the currently known ovens, the pastry or dough to be baked is subjected to a rotational movement around a vertical axis in order to take into account the non-homogeneities of the density of the microwaves in the oven. This mode of movement does not fully take into account the vertical non-homogeneities of the density of the wave or the other baking mechanisms, and it thus performs the baking of the pastry or dough imperfectly.

Finally, the ovens that are currently known do not make it possible to control the functioning of the baking mechanisms in a fine manner, by the power and the duration of functioning, for example, in a manner that is directly a function of the contents of the oven and of the different behavior that different foods can have, which are subject to the same baking mechanism.

### BRIEF SUMMARY OF THE INVENTION

The invention presented here thus intends to correct these different problems by the use of the partial vacuum within the oven itself in order to make the pastry or dough rise by the evaporation of water, this water being contained in a larger quantity in the pastry or dough, in conjunction with a customary combination of baking mechanisms, such as microwave and/or infrared, thus allowing its rapid setting by adapted baking mechanisms. A very accelerated baking of the pastry or dough to be baked results, markedly more rapid than with traditional ovens: the baking is done in conjunction with the rising of the pastry or dough by the evaporation of water which can make the pastry or dough rise by expanding.

In addition, the invention presented here includes a mechanism for setting in motion the bottom rack that carries pastry or dough, on many axes at a time, typically vertically and in rotation around this vertical axis in order to allow a perfectly homogeneous baking of the pastry or dough, in depth and on the surface, which constitutes a second goal of the invention presented here. The preparation of a complete dish (pizza, for example) can have one or more successive passages in the oven, with pre-baking possibly of the pastry or dough without ingredients, then followed by complete baking.

Finally, a third goal of the invention presented here is to be able to integrate the baking oven into a device that is larger and completely automated for the preparation of hot dishes according to the demands of a customer served very quickly by a fully automated distributor, where the selection of food is allowed for the customer, and the preparation of pizza, for example, is done with its baking method being totally adapted to the ingredients selected, and in a very short time, not exceeding a few minutes.

The device that is the object of the present invention is thus a pastry or dough baking oven having an inside volume that is set up to be adapted to the baking mechanisms used, for example reflecting microwaves for a microwave oven, and is impermeable to these microwaves to avoid dangers to the user, a bottom that is fixed or turns on which the food intended to be baked is placed, a system for driving in rotation the bottom food rack, if it is rotary, a mechanism at least for baking this food, generally placed in the upper part of the oven, a system for controlling the baking mechanisms and the time period they are used, a part that opens having a size fitted to the size given for the dishes intended to be baked, and in general, having at least a dimension greater than the diameter of the turning bottom, essentially characterized in that the method of operation combines:

By these arrangements, the pastry or dough to be baked, elevated rapidly by the action of the vacuum, for example, in ten to forty seconds depending of the residual pressure selected in the oven, is then fixed in its raised position by the baking that consists at the same time of mechanisms for baking inside the pastry or dough and for searing its surface.

According to a particular embodiment, the pastry or dough to be baked is subjected on the inside of the oven to a combination of movements in different directions in order to homogenize the baking of the pastry or dough.

By this arrangement, the baking of the pastry or dough is homogeneous in volume and in surface, by the successive passage of all zones of the pastry or dough in the same baking zones, thus taking into account the possible non-homogeneities of the local temperature of the oven or the density of the microwaves.

According to a preferred variation, the movement of the pastry or dough to be baked combines a rotational movement around an axis, for example, vertically, and a movement along a direction parallel to this axis.

By this arrangement, a simple mechanism allows the combination of the two movements in order make the homogeneous baking of the pastry or dough.

According to an even more particular embodiment, the same motor is used to cause movements along a vertical axis and in rotation around this axis, using an appropriate transmission system.

This device clearly makes it possible to simplify the creation of the oven. According to a particular embodiment, the lower part of the oven opens completely in order to make it possible to rapidly introduce the pastry or dough to be baked into the oven, including a bottom rack that carries the pastry or dough to be baked.

By this arrangement, the introduction and the extraction of the pastries or dough to be baked in the oven is greatly made easier, and it also allows an insertion of the pastry or dough baking oven into an assembly that is larger and mechanized and the positioning of the pastry or dough at a desired height relative to the heating element.

According to an even more particular embodiment, the oven is in an essentially cylindrical form, fitted to the form of the bottom racks that carry the pastry or dough, and the baking mechanisms are placed in a manner compatible with this form, for example, by being distributed around the upper part of this oven.

According to an even more particular embodiment, the oven has in its upper part on half of it, infrared tubes protected by a grate, ‘and on the other half, a system for baking by microwaves.

By these arrangements, the oven is best suited to support the mechanical stresses associated with the difference in pressure between the outside environment and the partial inside vacuum. In addition, its volume is reduced to the minimum relative to the surface area of the bottom racks that carry the pastry or dough to be baked. Its cylindrical form also ensures a relatively homogeneous reflection of the microwaves on the walls, contrary to the traditional ovens having a parallelepiped construction, the angles of which cause localized high densities of the microwaves. Finally, the division of the systems for baking in its upper part ensures a simple implementation and maintenance.

According to a particular embodiment, the treatment to which the pastry or dough is subjected inside the oven, the selection of the baking system(s) started and the time of baking, is programmed or programmable as a function of the pastry or dough to be baked and the intended goal.

By this arrangement, it is possible to adjust the time of baking, the partial residual pressure in the oven, and the power and time of baking as a function of the type of pastry or dough treated and of the intended goal, for example, pre-baking of the pastry or dough alone, or final baking with ingredients, and possibly as a function of the type and the volume of the added ingredients.

According to an even more particular embodiment, the treatment to which the pastry or dough is subjected follows the code written to the side of the pastry or dough on the pastry or dough bottom rack.

By this arrangement, the treatment of each pastry or dough introduced into the oven can be completely automated according to a code, for example, a bar code or a color code containing a baking mode and the baking time to be observed.

According to a particular embodiment, the device that is the object of the invention presented here consists of a system for the automatic manipulation of the bottom racks that carry the pastry or dough for their insertion into the oven and their extraction from this oven.

It is understood that by this baking mechanism, garnished pastries or dough can be accelerated or simply integrated in a system that is larger for preparation of baked pastries or dough or the automatic supply of baked pizzas by a distributor integrating all functions of preparation of the pastry or dough, and the baking of the pastry or dough and some ingredients.

The description which follows, made in reference to the attached drawings in the goal of explaining and not at all restrictive, makes it possible to better understand the advantages, goals and characteristics of the invention.

### BRIEF DESCRIPTION OF THE SEVERAL VIEWS OF THE DRAWINGS

FIG. 1 shows a device oven for baking pastry or dough according to the invention, seen in a sectional view in an open position.

FIG. 2 characterizes the movements of different components that make up the oven.

FIG. 3 shows a device according to the invention in a schematized view from above.

FIG. 4 shows the oven and its necessary accessory equipment as it is implemented.

FIGS. 5 and FIG. 6 show another embodiment mode of the oven according to the invention.

FIG. 7 schematizes the functioning principle of the oven.

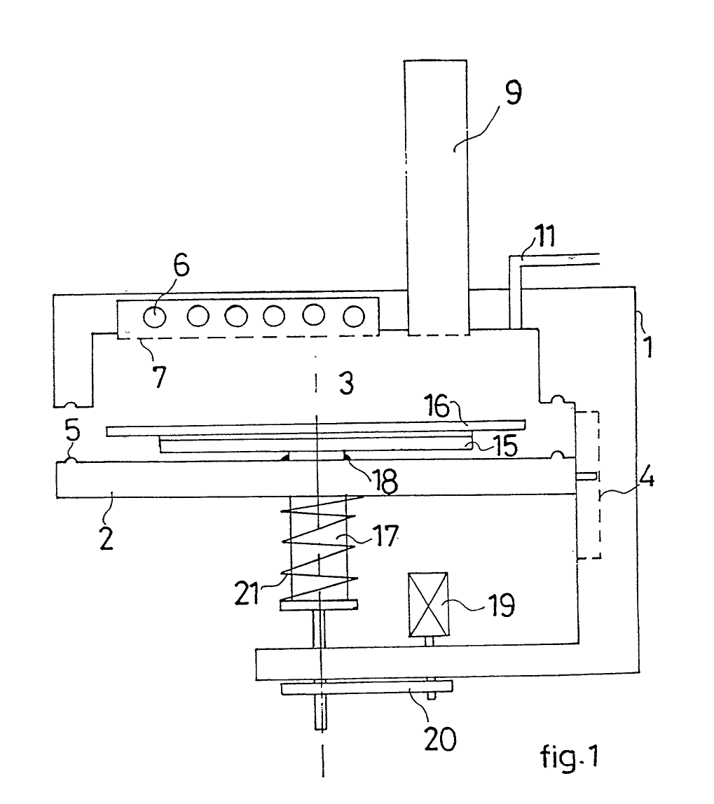

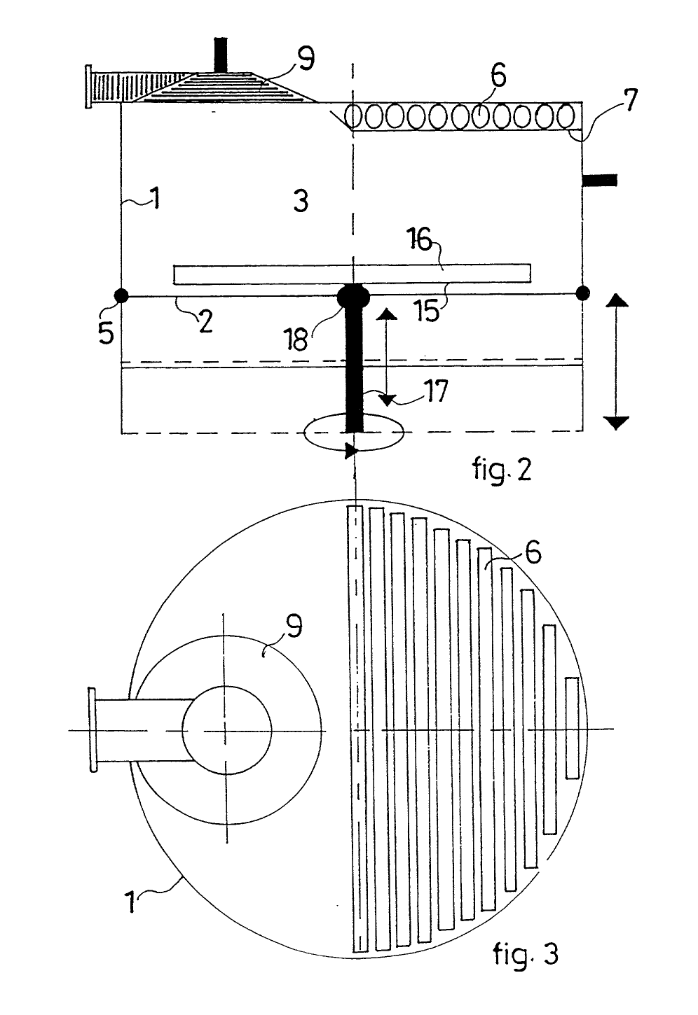

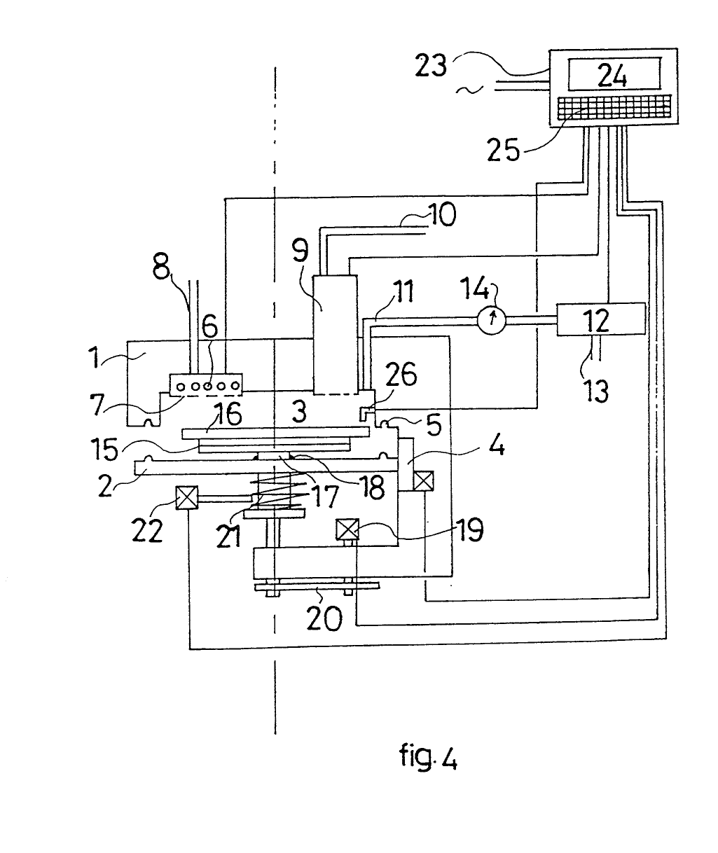

### DETAILED DESCRIPTION OF THE INVENTION

The underframe of the oven 1 is of traditional construction made of metal. It supports all of the other parts of the device. It has an upper part forming the upper part of the oven as such, and a lower part fitted to the support of the lower part opening up from the oven 2 and making it possible to position the pastry or dough at the desired height relative to the heating element, as well as the motors or mechanisms for setting in motion this lower part and the bottom rack that carries the pastry or dough to be baked. The baking zone 3 is determined by the upper part of the oven, the interior cylindrical form having a diameter fitted to that of the pastries or dough to be baked, and by the detachable lower part making up an oven door and support of the bottom rack that carries the pastry or dough to be baked.

The material that makes up the inside of the oven is of a type suitable for the reflection of microwaves generated by the microwave tube, and resistant to the temperature generated by the infrared systems. The material traditionally used in commercial microwave ovens will be used. The exterior part of the underframe is made in a manner to make up a Faraday's cage and to contain as completely as possible the emissions of microwaves inside the baking zone, thus avoiding any danger for the user of the oven. It is clear that the embodiment mode without a vision window for the user, nor a door joint on a side face, makes it possible to create more perfectly this impermeability to microwaves, by a wall of solid metal, continuing in all directions around the volume subject to microwave radiation. This type of oven thus constitutes by its form a baking element that is very safe for users.

The lower part of the oven is typically guided in a vertical movement in order to open and close the oven by a slide rail 4.

The closing of the oven is done hermetically by a joint 5, by inserting a joint made of rubber or other material, for example in the form of an O-ring seal. A sensor for complete closing of the oven, not shown here, will be placed between the fixed and mobile part of the oven, preventing for example, by a simple short circuit, the start-up of the oven if it is not hermetically sealed.

It can be noted that the desired impermeability to air, allowing by a pump a simple vacuum to maintain a residual pressure of 0.65 bars in the volume of the oven over a time duration of several dozens of seconds at most, is very easy to obtain by a simple joint, and that the impermeability of the connection to microwave radiation is markedly more significant. It is to be noted as well that the combination of baking by microwaves and by vacuum, according to this device, makes it possible to keep the opening part of the oven well pinned in the closed position due to the partial vacuum, and thus ensures an optimal impermeability of the oven during baking. An additional advantage is the suppression of baking odors due to the drawing in of gas during this baking. This can be advantageous when many people come to use the oven one after the other, without being bothered by the residual odors of the preceding baking. A traditional oven does not offer this characteristic.

The upper part of the baking zone contains on a half-surface, fixed infrared tubes, for example, in parallel to each other, on the underframe of the oven 1, and protected by a protection grate, for example, made of metal 7. These infrared tubes are supplied with energy by a traditional power supply 8, for example, 110-220 V 50-60 Hz.

The other half of the upper part of the oven is occupied by wave guide 9 suitable for the production of microwaves traditionally used in baking food. The magnetron is supplied with power by a traditional power supply 10, for example, 110-220 V 50-60 Hz. The power supplies 8 and 10 are possibly made up of a single device.

The baking devices can also be either infrared or microwave.

In the upper part of the baking zone, an aspiration pipe 11 is made in order to allow the evacuation of gases contained in the oven when it is put under partial vacuum of the baking zone. This aspiration pipe is protected by a fine grate that makes it possible to prevent food particles from getting where they could disrupt the proper functioning of the vacuum pump.

This ventilation pipe is connected by the tubes to a vacuum pump 12, which can be of the water ring type. It can be typically rotary and suitable for the creation of a residual pressure consisting of between 0 to 1 bar, preferably −0.65 bar in a baking zone having a volume of approximately 25 dm3. This pump is supplied by a power source 13, for example, electric of the traditional type and possibly common with the supply of the baking systems. A manometer 14 can be possibly installed on the circuit of the vacuum in order to control the implementation and the quality.

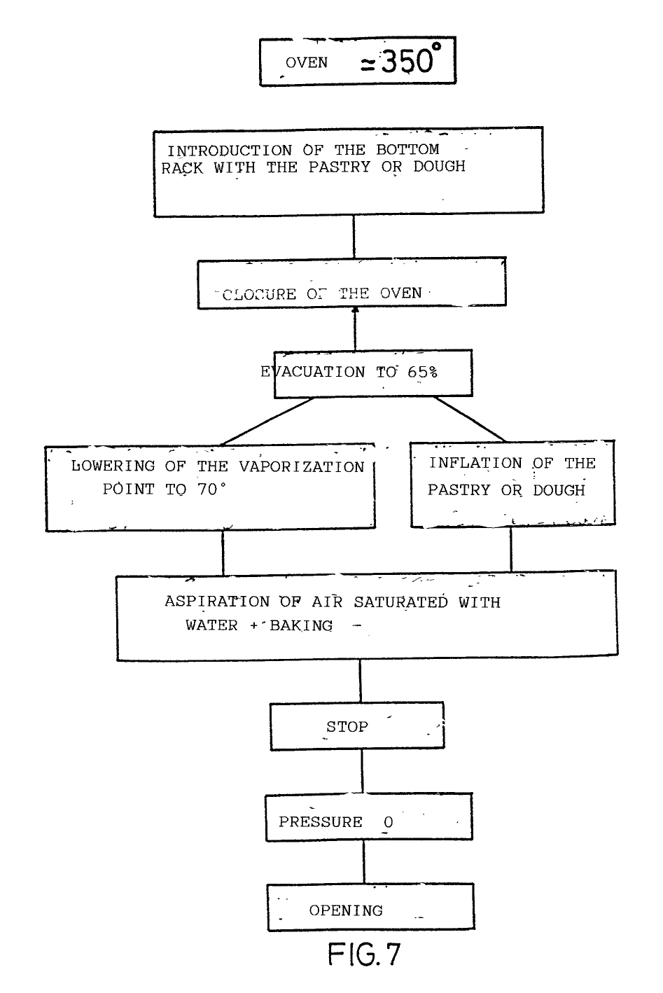

The functioning of the oven is shown in FIG. 7 by a block diagram. The oven is at the start of the cycle at a temperature on the order of 350°. The bottom 16 is introduced into the oven; the oven is thus closed. The vacuum is made in the oven. The vacuum has a value which can be variable: a value of 65% being given as an example.

The creation of the vacuum inside the oven performs a simultaneous double function:

lowering the pressure causing the pastry or dough to inflate;

lowering the point of vaporization to approximately 70° by the action of Mariotte's Law making it possible to reduce the baking time under low pressure.

The pastry or dough is a dough of the bread type without rising agent, containing 50% plus or minus 5% water, the standard is 33% water: this dough is made at the instant or a short time before baking, the water and the flour being mixed at the moment. When the dough is put into the heated enclosure of the oven, the dough can be raised during the partial vacuum by continuing to pump; the vacuum (65%) is maintained and air saturated with water is aspirated, which is vaporized at70° C.

The aspiration is done along with the baking. The aspiration is then stopped, the pressure returns to zero inside the oven and you can open the oven: the pastry or dough has risen and is baked.

The pastry or dough is raised by the evaporation of water by the vacuum that reduces the temperature of vaporization and reduces the baking temperature.

The vaporization of water which inflates under the effect of the low pressure generates bubbles trapped within the pastry or dough, making it inflate.

The effect of the vacuum makes it possible to vaporize a larger quantity of water and with the invention, you can then raise and bake the pastries or dough at a liquid or semi-liquid consistency.

Inside the baking zone, the plate 15 supporting the bottom 16 designed to accommodate the pastry or dough to be baked is mounted on a vertical support 17 merged with the vertical axis of the oven. The bottom 16 (and its plate) can also be affixed in position. This support, made for example, of two coaxial tubes having different diameters, provides for the system the setting into motion of the plate bottom rack, both for the rotation movement and for the vertical movement. This support traverses the lower part that opens from the oven 2. The impermeability is ensured by a seal 18.

The setting into rotation of the plate bottom rack is typically done by the action of a motor 19, which can advantageously be of the traditional electric type supplied, for example, with 110-220 V 50-60 Hz. A reducing gear or a transmission 20 ensures the setting into rotation of the plate bottom rack.

The setting into vertical movement of the plate bottom rack is done by the intermediation of a screw or cam system 21 that can be activated either by a motor 22 that is typically electric, or by the intermediation of a transmission from the motor 19.

The different components of the oven (opening part, motor for rotation of the plate bottom rack, transmission for the rotation of the plate or for its vertical movement, vacuum pump, waveguide, infrared tubes) are controlled by a system of command and control 23, for example, electronically or by computer and programmed or programmable. This system of control consists traditionally of a sole traditional power supply 110-220 V, 50-60 Hz, having a power adapted to the maximum theoretical consumption of the assembly of the functioning components. This power supply can then supply the assembly of components, either with alternating current (AC) or direct current (DC) depending on the characteristics of the components selected for the creation of the oven.

The control system can if necessary be adapted for the simultaneous monitoring of several baking units. It is, for example, imaginable to place in a same general unit for the automated preparation of pastries or dough, several ovens having a size barely larger than the expanded size of the pastries or dough to be baked, for example, at least twenty centimeters in diameter for pizzas for one or two people, monitored by a single system for the treatment of the baking, this reducing the overall congestion of the distributor, and allowing the creation in parallel of several pizzas, since the oven is the component which takes the most time.

The control system for the oven includes a user interface based, on the one hand, either on a series of controllers 24 at the level of the manometer or wattmeter, or on a screen for displaying the parameters and alarms, and, on the other hand, on a keyboard for entering data 25, or on the control switches of the components, or simply an interface for the selection of ingredients to be placed on the pastry or dough, the control software ensuring the calculation of the baking time and the baking method suited to this combination of ingredients.

The selection of a computer control system also makes it possible to increase the progressiveness of the oven, in authorizing the insertion of the program that is the most developed in the future, according to the evolution of the knowledge of baking or the addition of sensors that are finer, for example, in the pastry or dough itself.

A detector of the type of product to be baked 26 will possibly be installed on the side edge of the baking zone in order to start the functioning of the control system 23.

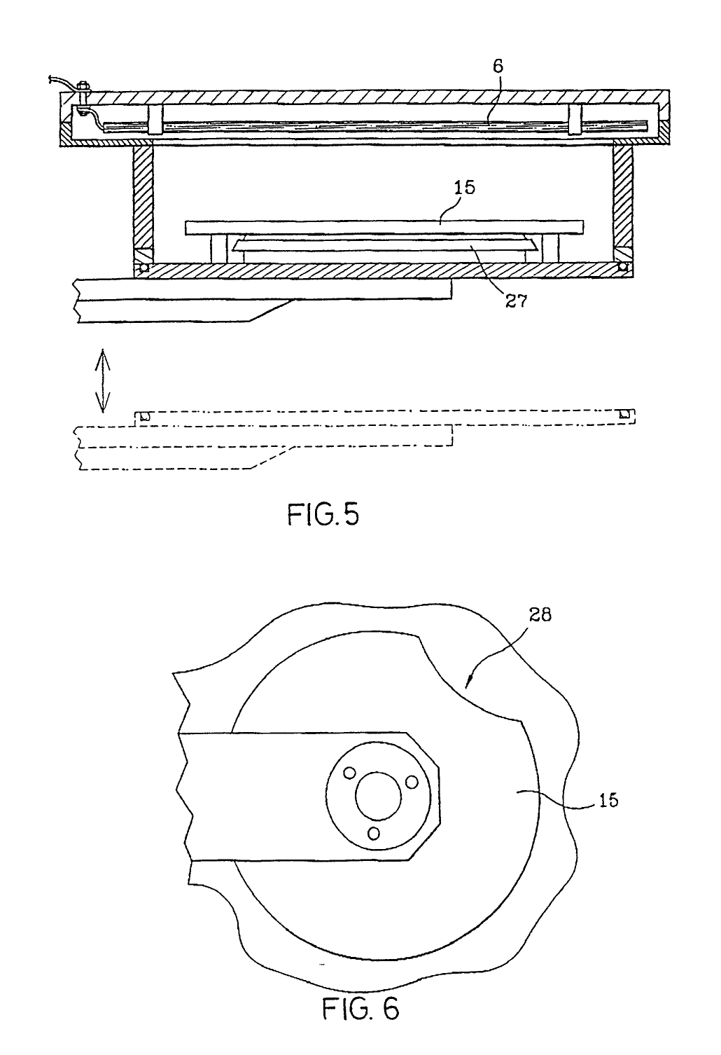

In FIGS. 5 and 6, another embodiment mode of the invention is shown in which the baking is done only by the heating action of the infrared tubes 6 of the upper part of the oven and by a heating plate 27 arranged under the plate 15.

According to the invention, the plate 15 receives a bottom rack that carries the pastry or dough, not shown, which can come from an accessory device that pours out the pastry or dough and/or the seasonings.

Advantageously, this bottom is governed by automated mechanical mechanisms. In order to make easier the manipulation of the bottom rack that carries the pastry or dough, which is in the circular form, the plate 15 has on its upper surface an indexing slug to which a groove or a gap of the bottom corresponds and the heating plate has a gap slot 28 (FIG. 6) that makes it possible to return the bottom, which goes past this directly graspable gap without touching the plate.

The gap slot 29 is formed in an arc of the curve in order to open up a zone over which the bottom rack that carries the pastry or dough passes. According to this embodiment, the plate 15 is a fixed non-rotating plate that follows an ascending and descending movement corresponding to the closing and opening of the oven by its lower mobile part 2.

According to this embodiment form, the oven can function in partial vacuum by the effect of the vacuum as mentioned above, or without a partial vacuum.

I claim:

1. A method of baking bread dough using a baking oven having an interior volume, the baking oven having a bottom upon which the bread dough can be placed, the baking oven having a mechanism for baking the bread dough positioned in an upper part thereof, a controller being connected to the mechanism, the oven having an openable door and a pump, the method comprising:
blending water with a bread dough in which the water has a weight percentage of between 45% and 55% of the total blended composition, said blending being without a raising agent;
placing the blended bread dough on the bottom of the baking oven;
baking the blended bread dough while applying a partial vacuum to the interior volume by the pump so as to cause a raising of the bread dough by the evaporation of water in the bread dough;
fixing the raised bread dough by the baking mechanism subsequent to the step of baking; and
searing an exterior surface of the fixed raised bread dough.

2. The method of claim 1, further comprising:
aspirating the air in the interior volume during the step of baking.

3. The method of claim 1, further comprising:
controlling the functioning of the baking mechanism by the power and/or the duration of functioning in a manner that is a function of a composition and a volume of the blended bread dough placed in the oven.

4. The method of claim 1, further comprising:
controlling the pressure during the baking step in accordance with the type of blended bread dough.

5. The method of claim 1, further comprising:
controlling the pressure during the baking step in accordance with the percentage of water in the blended bread dough.

6. The method of claim 1, wherein the oven comprises a reader capable of reading a code on a side of the bread dough or on a side of a dough bottom rack, further comprising:
providing a code written to the side of the bread dough or dough bottom rack,
reading the code and
controlling the mechanism for baking the bread dough in accordance with the code.

7. The method of claim 1, further comprising:
detecting the type of bread dough to be baked, and
controlling the mechanism for baking the bread dough in accordance wit type of product to be baked.

8. The method of claim 1, wherein the step of baking comprises:
pre-baking the bread dough alone without added ingredients and
final baking of the pre-baked bread dough with added ingredients.

9. The method of claim 8, further comprising:
detecting the type or the volume of the added ingredients, and
controlling the mechanism for baking the bread dough in accordance with the type or volume of the added ingredients.

10. The method of claim 1, further comprising:
heating the interior volume at a temperature on the order of 350 Celsius degrees before the step of placing the bread dough.

11. The method of claim 1, wherein fixing the raised bread dough is Performed by using infrared rays.

12. The method of claim 1, further comprising:
moving the bottom in different directions during the step of baking the blended bread dough.

13. The method of claim 11, further comprising:
rotating the bottom around a central axis thereof, and
moving the bottom in a direction parallel to said central axis.

14. The method of claim 11, wherein the oven comprises a door to open a lower part of the oven, further comprising:
opening said door completely so as to allow the blended bread dough to be placed on said bottom before the step of placing the blended bread dough.

15. A method of baking food in liquid or semi-liquid consistency using a baking oven having an interior volume, the baking oven having a bottom upon which the food can be placed, the baking oven having a mechanism for baking the food positioned in an upper part thereof, a controller being connected to the mechanism, the oven having an openable door and a pump, the method comprising:
blending water with the food to cause the food to have a liquid or semi-liquid consistency, said blending being without a raising agent;
placing the blended food on the bottom of the baking oven;
baking the blended food while applying a partial vacuum to the interior volume by the pump so as to cause a raising of food by the evaporation of water in the food;
fixing the food by the baking mechanism subsequent to the step of baking; and
searing an exterior surface of the fixed raised food.

16. The method of claim 15, further comprising:
aspirating the air in the interior volume during the step of baking.

17. The method of claim 15, further comprising:
controlling the functioning of the baking mechanism by the power and/or the duration of functioning in a manner that is a function of a composition and a volume of the blended food placed in the oven.

18. The method of claim 15, further comprising:
controlling the pressure during the baking step in accordance with the percentage of water in the blended food.

19. The method of claim 15, further comprising:
detecting the type of food to be baked, and
controlling the mechanism for baking the food in accordance with the type of food to be baked.

20. The method of claim 15, further comprising:
moving the bottom in different directions during the step of baking the blended bread dough.
